(19) United States
(12) Patent Application Publication
(10) Pub. No.: US 2010/0266369 A1
(43) Pub. Date: Oct. 21, 2010

(54) Round Bale Trailer

(75) Inventor: Ross Munro, East Moree (AU)

Correspondence Address: MICHAEL MOLINS;MOLINS & CO., SUITE 5, LEVEL 6, 139 MACQUARIE ST, SYDNEY NSW, 2000, AU

(73) Assignee: BMC Partnership Pty Ltd., East Sydney (AU)

(21) Appl. No.: 12/485,912

(22) Filed: Jun. 17, 2009

(30) Foreign Application Priority Data
Apr. 16, 2009 (AU) 2009901611

(51) Int. Cl. A01D 90/00

(52) U.S. Cl. 414/24.5

(57) ABSTRACT

A transport trailer for carrying round bales of cotton or other product is disclosed. The trailer carries a flat transport bed adapted to pivot about a wheel assembly and having one or more of longitudinal conveyors. The bed has one or more compression stations, each station comprising one or more pairs of stabilisers located on opposite side edges of the bed. Each compression station can laterally compress a bale and stabilize it for road transport.

### FIELD OF THE INVENTION

The invention relates to trailers and more particularly to a trailer for loading and discharging plastic film wrapped round bails such as cotton bales.

### BACKGROUND OF THE INVENTION

It is well known that cotton harvesting machinery is adapted to form and wrap round bales from harvested cotton and deposit such bales in the field, for collection. Such round bales can be collected by trucks towing trailers. Such trailers have flat beds equipped with multiple chain conveyors for loading the cotton bales. However, recent trends in cotton baling have made it necessary to develop trailers that can load ever larger. Without the ability to alter the shape of the bale, the combination of trailer and loaded bales would be too wide to be roadworthy.

### OBJECTS AND SUMMARY OF THE INVENTION

It is an object of the invention to provide a trailer for wrapped, round cotton bales. The trailer has a flat bed, chain conveyor and one or more stations for laterally compressing the bales into a configuration that can be made roadworthy.

Accordingly, there is provided a flat bed trailer having multiple longitudinal chain conveyors. The flat bed of the trailer is adapted pivot and a ground contacting end of the flat bed carries a crawler for propelling the flat bed forwards and backwards. The flat bed of the trailer also comprises one or more compression stations. Each station comprises a stabiliser that is hydraulically activated from a loading position into a transport position. In the transport position, a bale located between the stabilisers is compressed. Each station may optionally comprise orientation bumpers.

In preferred embodiments, each stabiliser in an opposing pair further comprises a transverse support.

In some embodiments, a loading gate is provided. The loading gate comprises a pair of swing arms, each equipped with one or more rollers that rotate about a generally vertical axis. The swing arms move from an open or loading position to a closed or transport position.

### BRIEF DESCRIPTION OF THE DRAWING FIGURES

In order that the invention be better understood, reference is now made to the following drawing figures in which:

FIG. 1 is a schematic side elevation of a truck having a trailer constructed in accordance with the teachings of the present invention;

FIG. 2 is a schematic side elevation of the device depicted in FIG. 1 showing the pivoting trailer making ground contact using the crawler;

FIG. 3 is an end elevation showing the compression of a bale once loaded;

FIG. 4 is a perspective view of one half of a compression station;

FIG. 4a is an end elevation of one half of a compression station;

FIG. 5 is an end elevation depicting the loading gate in a transport orientation;

FIG. 6 is an end elevation showing the loading gate in a loading orientation;

FIG. 7 is a perspective view showing how a guide skirt is affixed to a fixed bumper;

FIG. 8 is a top schematic view showing the insulation of the guide skirt;

FIG. 9 is a schematic perspective view of an alternate embodiment of the invention;

FIG. 10 is an end elevation of yet another embodiment of the invention.

### BEST MODE AND OTHER EMBODIMENTS

This specification incorporates, by reference, Australian Application No. 2008207644. It discloses a type of chain conveyor that may be used with the following technology.

The present description provides teachings relating to the handling of bales of cotton. It will be understood that these teachings apply to bales of other products and that the use of the technology is not limited to cotton bale handling.

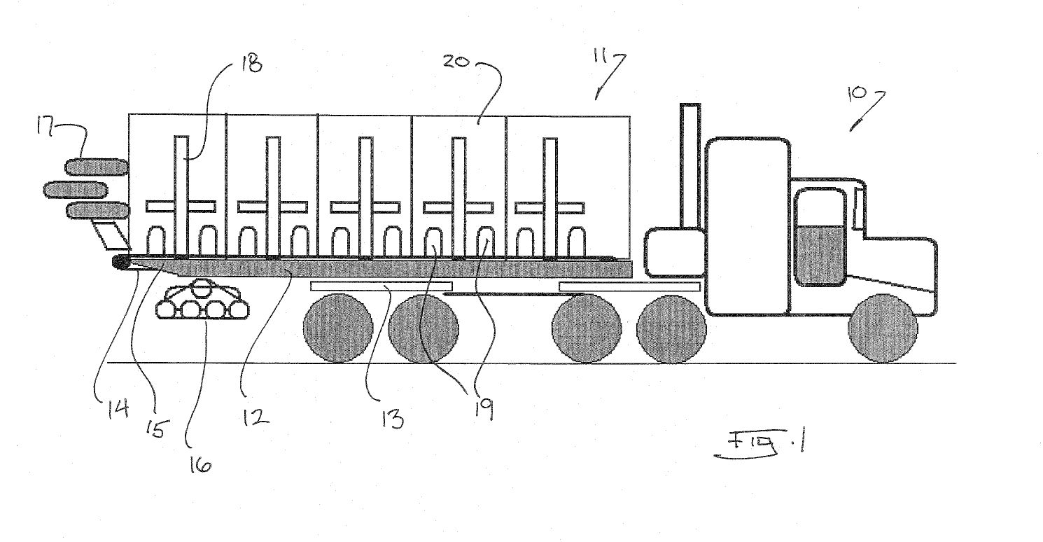

As shown in FIG. 1, a prime mover 10 such as a truck or tractor unit or the like is adapted to carry a flat bed for carrying loads, such as a trailer 11. The trailer 11 comprises a flat transport bed 12 and is adapted to pivot about a wheel assembly or wheel bogie 13. The bed 12 carries a number of longitudinal chain (or other) conveyors 14 as is common practice in trailers used for collecting cotton bales. It will be noted that other forms of continuous conveyor may be used such as rubber belts, articulated plates or the like. The conveyors 14 extend fore and aft from one end of the bed 12 to the other. The rear end 15 of the bed may be tapered to allow the conveyors to be located closer to the ground. A crawler or motorised track module 16 is located below the rear end 15 of the bed. The trailer 11 further comprises a pivoting, loading and transport gate 17 and one or more compression stations 18. Each station 18 comprises a pair hydraulic stabilisers located on opposite side edges of the bed 12. In this example, a pair of orientation bumpers 19 is provided for each stabiliser. The compression stations act to laterally compress a bale, stabilise it for transport over road and reduce the effective width of the bales to comply with applicable road rules.

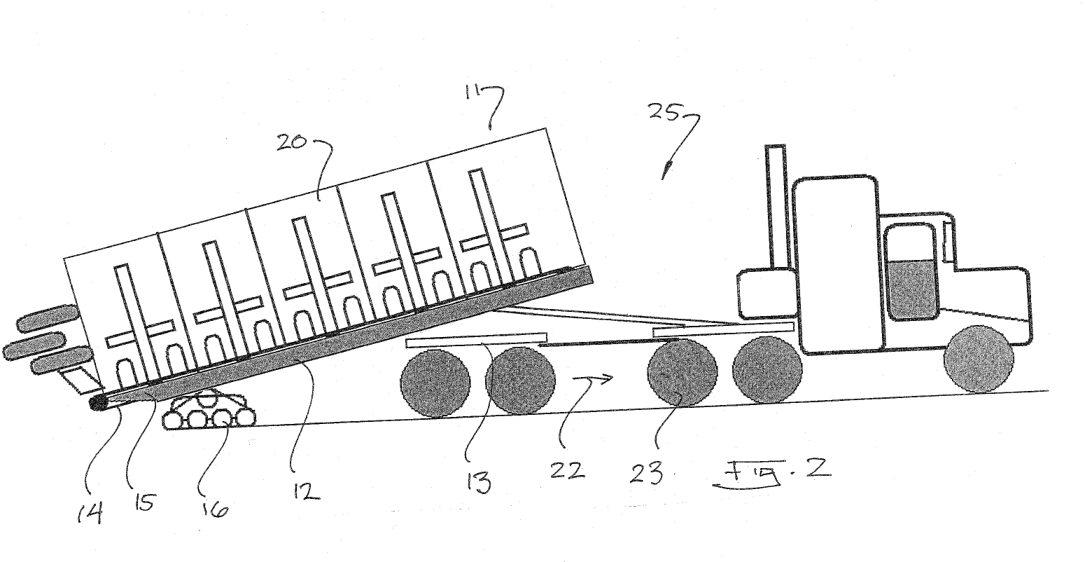

As shown in FIG. 2, the trailer's bed 12 pivots around a two axle wheel assembly 13. The trailer's bed pivots under the influence of gravity as the rear, two axel wheel assembly 13 is caused to advance 22 toward the set of jack wheels 23. This can be done using hydraulic pistons or the like. As the wheel assembly 13 advances 22, the bed 12 becomes out of balance and the rear end 15 of the bed tips toward the ground. In this orientation, the crawler 16 makes ground contact. With the crawler in contact with the ground, its hydraulically powered tracks are activated so that the entire vehicle 25 (including prime mover and trailer) can be moved forward and backward relative to the bales that have been pre-arranged on the ground. As is well known in this art, the entire vehicle is propelled backwards when collecting bales and propelled forward when discharging bales. The chain conveyors 14 propel bales forward and onto the bed when loading and are able to discharge bales from the rear end 15 when unloading.

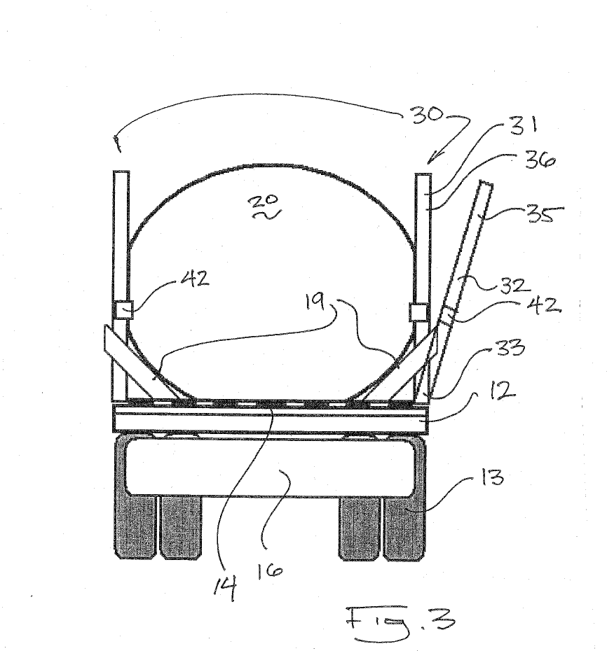

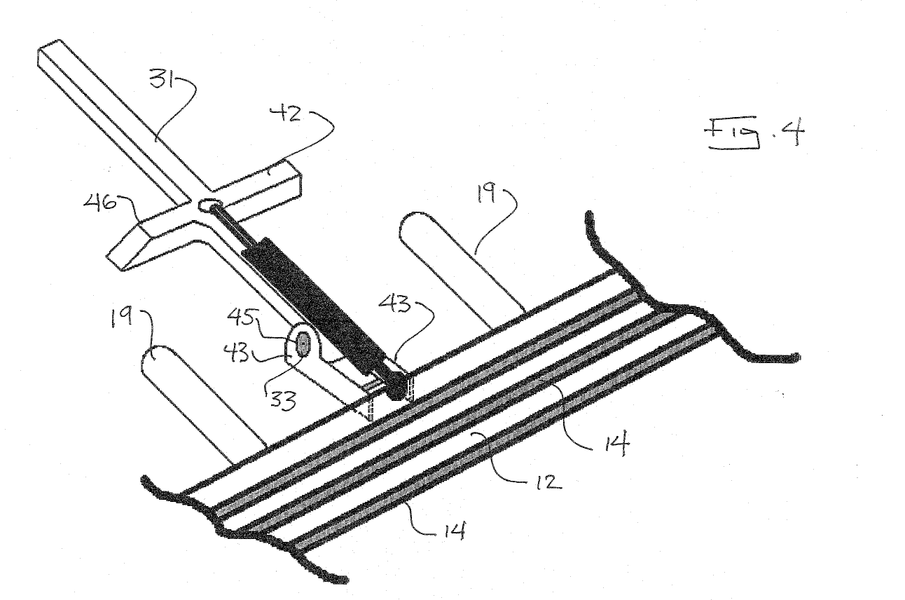

As shown in FIG. 3, each compression station 30 comprises a pair of opposing hydraulically activated stabilisers 31 adapted for lateral compression of one or more bales. For clarity, the pivoting gate 17 is not shown in this view. Stabilisers 31 are located opposite one another along the side edges of the bed 12. As suggested by FIGS. 3 and 4, each stabiliser 31 comprises a rigid upright, post or beam 32 that is pivoted at its lower end 33 with respect to the bed. A hydraulic cylinder (see FIG. 4) 41 is affixed between the bed 12 and the stabiliser 31. Thus, under the influence of the hydraulic cylinder 41, the stabiliser 31 can assume a continuity of positions including an open or loading position 35 and a vertical transport position 36. In the loading position 35 the stabiliser 31 is pivoted outboard of the width of the flat bed 12 and with its opposite stabiliser is adapted to create a gap into which a round bale can easily fit. The orientation bumpers 19 act to facilitate the smooth movement of the bales into position as they are propelled forward by the conveyors 14. The orientation bumpers are round, steel pipe located to either side of a stabiliser 31 and set at a roughly 45 degree angle with respect to bed 12. The bumpers 19 may optionally incorporate a roller mechanism. The bumpers 19 prevent the bale's forward motion from being interfered with by the stabilisers 31. Similarly, the bumpers 19 protect the stabilisers 31 from being impacted by the bales 20. In this example, each stabiliser 31 includes a transverse brace 42. In this example, the transverse brace 42 is a rigid member that is welded to the post 31. The brace 42 distributes the compression stress exerted by the stabiliser across a greater area on the bale than would otherwise occur. Each stabiliser may incorporate one or more braces 42 of any of a variety of shapes and sites. Note that one or both ends of the transverse brace 42 may be tapered 46 to prevent binding and ease the motion of the bale as it passes over the stabiliser.

As shown in FIG. 4, the post 31 is pivotally supported between a pair of metal side brackets 43. The brackets are carried by the bed 12. Bearings at the pivot point 45 support the stabiliser for rotating motion about its lower end 33. As better shown in FIG. 3, once a bale 20 is loaded between the stabilisers of a compression station 30 the hydraulic ram 41 is shortened to bring a stabiliser 31 into a generally upright or vertical transport orientation. The bale is compressed horizontally so that it fits comfortably within the width of the trailer. In particular, with the stabilisers in the transport position, the bale is narrower than the width of the bed 12 and is the same width as the distance between the stabilisers 31. Without this lateral compression, the bale would be too large to transport on public roads.

In preferred embodiments, and as shown in FIG. 4a, the transverse brace 42 is preferably welded to the interior surface 47 of the stabiliser 31. This creates a gap between the bale contacting part of the brace 48 and the upright stabiliser 31. This reduces the chances that the bale will bind on the stabiliser 31. This feature also creates additional compression on the bale where it is most useful. Note that the hydraulic ram 41 is pivotally attached to the stabiliser 31 at a point below the transverse brace 42.

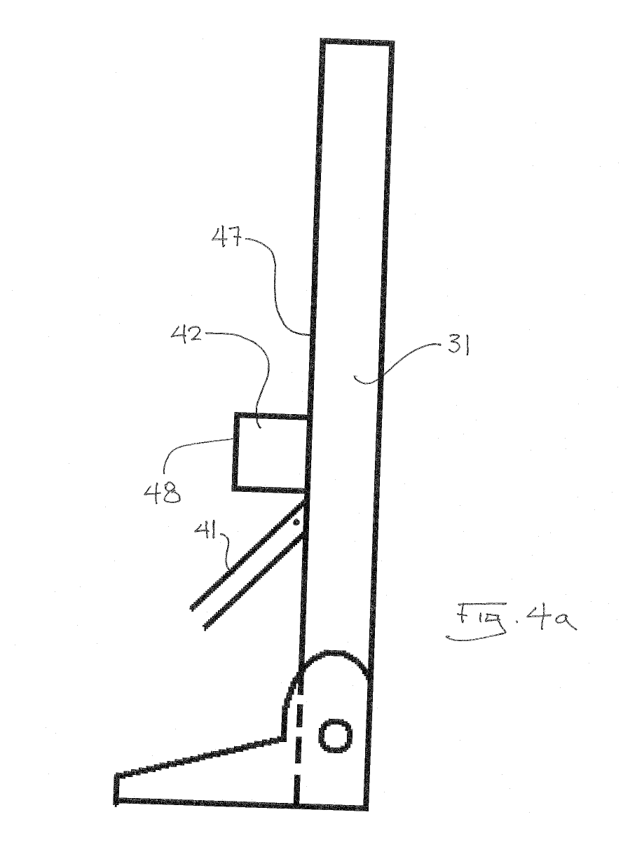

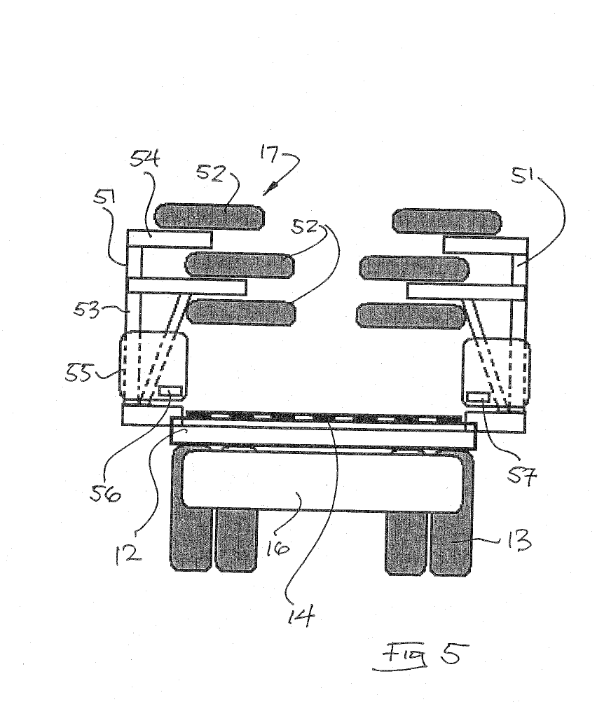

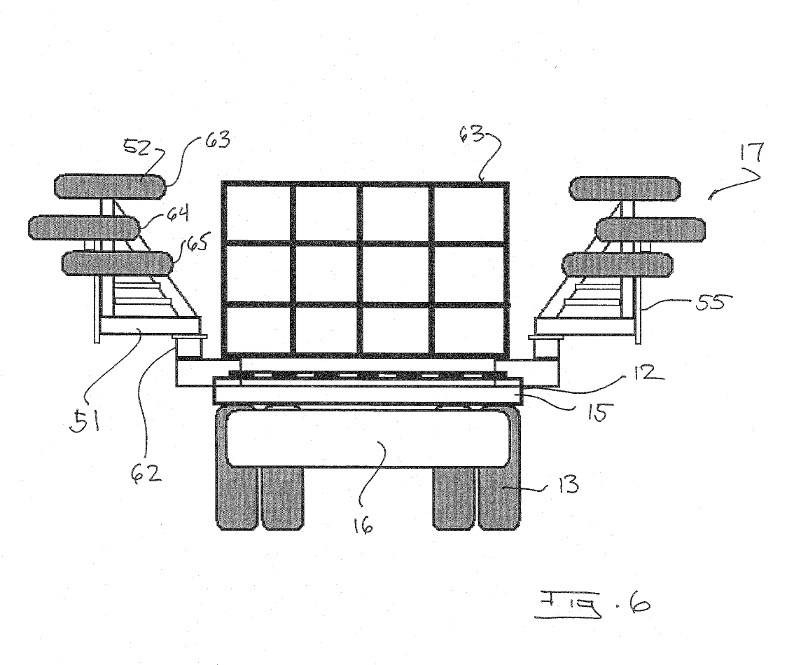

As shown in FIGS. 5 and 6 a transport trailer for round cotton bales is provided with a pivoting gate mechanism 17. The pivoting gate 17 comprises an opposing pair of swing arms 51, each supporting, in this example, three rotating bumpers or pneumatic tires 52. A swing arm 51 comprises a vertical upright 53 and horizontal members 54, as required to support the rotating tires 52. Each pivot arm 53 of the gate is adapted to carry a road sign 55 warning lights and turn signals 56 or a licence plate 57, as required. In FIG. 5, the gate 17 is shown in a closed orientation and ready for transport. In this orientation, tires 52 block the open end of the bed 12 so that the bales 20 cannot be inadvertently discharged.

In FIG. 6, the gate 17 is shown in a loading orientation. In this orientation, the swing arms 51 have been pivoted with their respective hydraulic motors 62 so that the vertically stacked, vertical axis rollers or tires 52 no longer block the rear end 15 of the bed 12. Note that in the elevation view of FIG. 6, the tires 52 are stagger mounted for rotation in a horizontal plain so that the bale contact points of each tire 63, 64, 65, conform to the size and rounded exterior shape of a bale. It will be understood that the gates 17 may be opened and closed while the bed is in the ground contacting orientation depicted in FIG. 2. FIG. 6 also illustrates that the front of the bed 12 may carry a fixed metal frame 63. The frame 63 is as wide as the bed 12 and about as tall as a bale 20 and prevents the bales from moving forward during deceleration of the trailer or, for example, when travelling down hill.

In the above examples, it will be appreciated that the trailer of the present invention has been disclosed as having five independent compression stations. It will be appreciated that the number of compression stations is not material to the invention and that practically any number of compression stations may be utilised on a trailer. In effect, each side may be operated as a single independent compression station. Similarly more than five compression stations per side may be used. It has also been disclosed that a single bale is retained by a single compression station. It will be appreciated that a single compression station may be wide enough to handle two or more bales and that two or more compression stations may be used to retain a single bale.

An optional feature of the present invention is a guide skirt 70. The skirt 70 comprises a heavy but flexible polymer sheet that extends along the length of the edge of the bed of the trailer. As previously explained, the bumpers 71 extend away from the bed at an angle of about 45 degrees. The skirt 70 lies flat across the bumpers. Some or all of the bumpers 71 have a flat rectangular plate 72 welded or otherwise affixed to an upper surface. The plate 72 provides a flat point of attachment for affixing the skirt 70. A pair of smooth headed fasteners 73 is used to attach the skirt 70 to each plate 72. This allows the upper edge 74 of the skirt to flex in accordance with the movement of the stabilisers 75. In this example, the bumpers 71 and stabiliser assembly 75 are shown as located below the skirt 70. Note that the upper edge of the skirt 74 does not reach as high as the cross piece 76. Thus, it cannot interfere with or be interfered with by the cross piece 76.

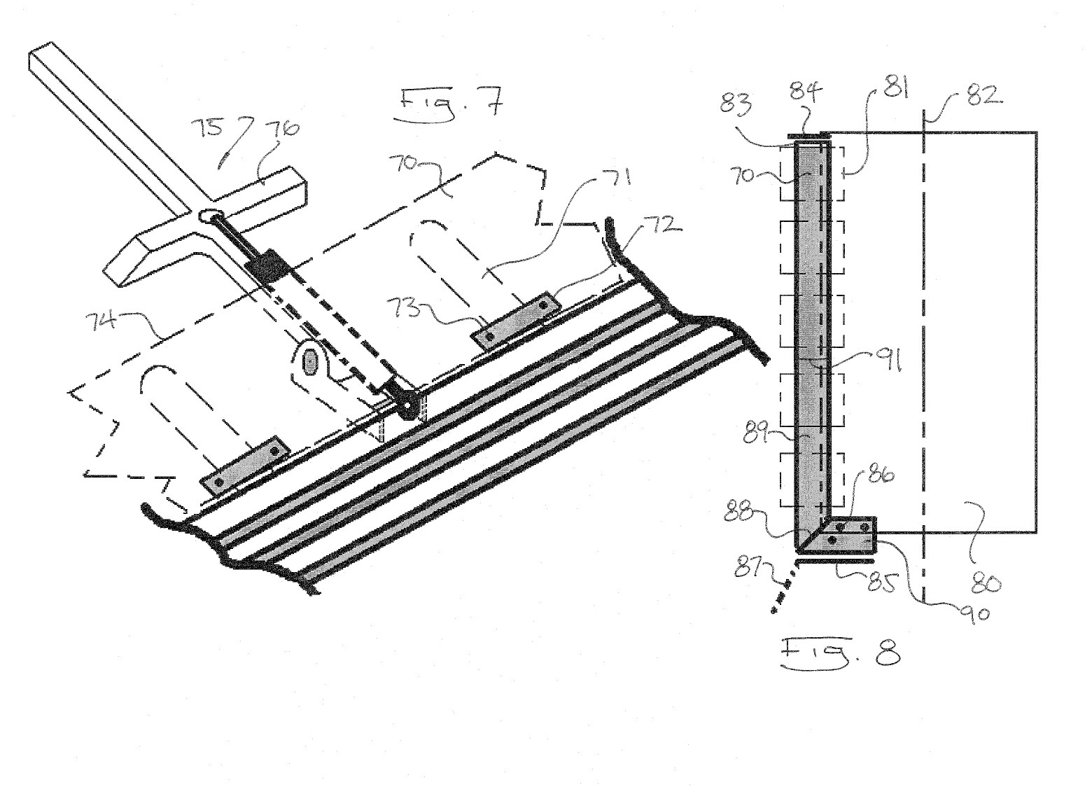

As shown in FIG. 8, the skirt 70 extends substantially the length of the bed 80 of the trailer. The skirt 70 is shown in relation to schematic depictions of the five stabiliser components 81 located on one side of the longitudinal centre line 82 of the trailer. The forward edge 83 of the skirt 70 is affixed to a straight, rigid steel angle 84 that also extends at approximately a 45 degree angle to the bed. In the example of FIG. 8, the skirt also covers the interior face of the pivoting gate mechanism 85. It is affixed at various points 86 to the interior face of the gate mechanism and allows the gate mechanism to move from the closed position to the open position 87. An angled joint 88 between the major length of the skirt 89 and that part covering the gate portion go provides adequate flexibility. Because of the length of the major extend 89, individual sections may be joined at a transverse seam 91, by threaded fasteners or the like.

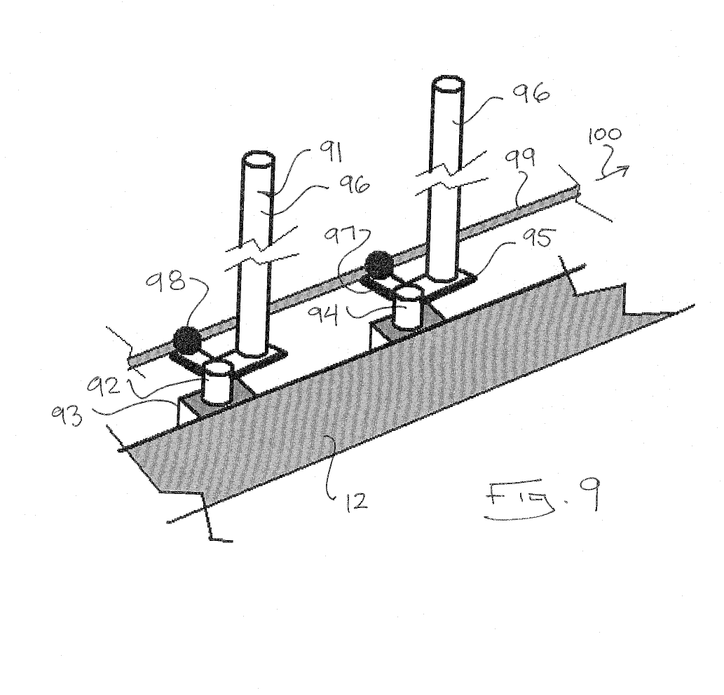

As shown in FIG. 9 compression of the cotton bales may be achieved by a variety of mechanisms in addition to those ones already disclosed. In this example, rotating crank-like compression station halves (rather than pivoting ones) are distributed along the side of the bed 12 in the manner suggested by FIGS. 1 and 4. In accordance with those examples, each compression station half 91 has a corresponding half (not shown) along an opposite edge of bed 12. In the example of FIG. 9, each compression station half 91 comprises a rotating crank 92 that is supported by bearings 93. A rotating stub shaft 94 carries a crank arm 95 to which is attached a rigid upright 96. In this example, the stub shaft 94 also carries a second arm 97 that carries a joint, link, linkage, articulated joint, ball joint or the like 98. This allows all (or some) of the compression station halves 91 along one side to be operated by interconnecting them with rigid rods 99 that extend between station halves. Thus, reciprocation of one end of the assembly of rods and joints 98, 99 causes the rotation of one or more of the compression station halves 91. In the position illustrated, the uprights 96 allow the bales to be loaded. Advancement of the rods 99 in the direction of the arrow 100 causes the uprights to be rotated into a compression position against the loaded bales.

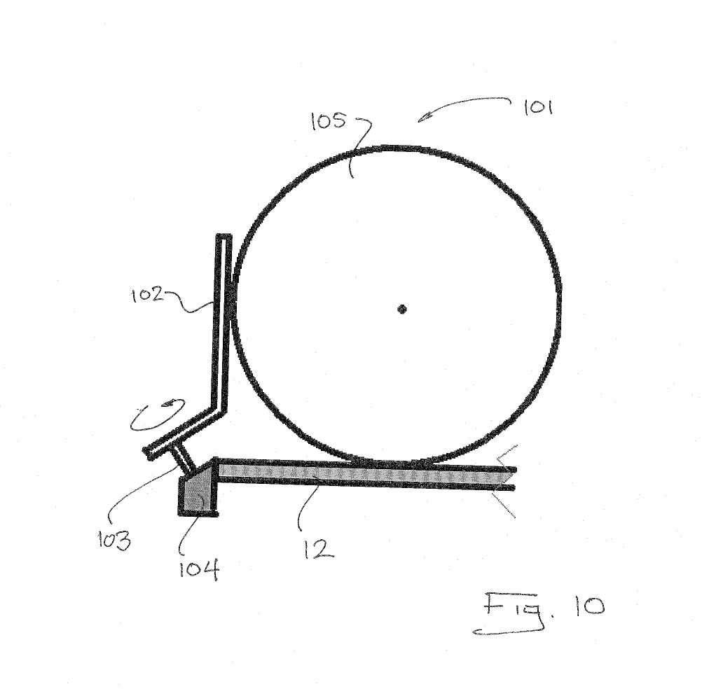

Another embodiment based on crank arm rotation 101 is depicted in FIG. 10. In this example, bent compression station arms 102 are rotated by a shaft 103 that is inclined with respect to vertical. The rotating shafts 103 are carried by bearings or a gear box or hydraulic motor or actuator 104 etc. In the orientation depicted in FIG. 10, the crank-like rotating compression arms 102 are in contact with and act to compress the cotton bale 105. When the shaft 103 is rotated in either direction, the rigid compression arm 102 will cease engagement with the bale 105, thus allowing loaded or unloading. The rigid uprights seen in FIGS. 9 and 10 may have smooth or low friction or independently rotation working surfaces that facilitate the movement of the uprights against the plastic sheet surfaces of the bales.

While the present invention has been disclosed with reference to particular details of construction, these should be understood as having been provided by way of example and not as limitations to the scope or spirit of the invention.

1. A trailer for carrying over sized bales, comprising:
a wheel assembly;
a flat bed that pivots about the wheel assembly;
the flat bed comprising a longitudinal conveyor that extends from one end of the bed to another end and is adapted to propel bales forward and onto the bed when loading, and one or more compression stations for reducing the effective width of a bale;
wherein the one or more compression stations each include a pair of stabilisers located on opposite side edges of the bed;
each compression station is adapted to have a compressed orientation wherein a stationary bale on the bed is laterally compressed and an open orientation wherein the bale is not compressed;
a rear of the bed supporting a crawler for propelling the trailer backward when collecting bales.

2. The trailer of claim 1, wherein:
the bed pivots under the influence of gravity as the wheel assembly advances toward a set of jack wheels.

3. The trailer of claim 1, wherein:
each compression station comprises a pair of opposing hydraulically activated stabilisers, each stabiliser comprising a rigid post that is pivoted at its lower end with respect to the bed and a hydraulic cylinder affixed between the bed and the stabiliser.

4. The tailer of claim 3, wherein:
a compression station is associated with a pair of orientation bumpers that facilitate a movement of the bales as they are propelled forward by the conveyors.

5. The tailer of claim 4, wherein the orientation bumpers are located to either side of a stabiliser and set at an angle with respect to bed.

6. The tailer of claim 4, wherein:
a stabiliser includes at least one transverse brace being a rigid member that is welded to a post.

7. The tailer of claim 6, wherein:
at least one end of the transverse brace is tapered and the hydraulic cylinder is pivotally attached to the stabiliser at a point below the transverse brace.

8. The tailer of claim 6, wherein:
a hydraulic ram is pivotally attached to the stabiliser at a point below the transverse brace.

9. The tailer of claim 1, wherein:
a pivoting gate mechanism having an opposing pair of swing arms, each supporting one or more rotating bumpers.

10. The tailer of claim 9, wherein:
the rotating bumpers are two or more on each swing arm mounted for rotation so that a bale contact point of each bumper conforms to the size and shape of a bale.

11. The tailer of claim 1, wherein:
a single compression station is wide enough to handle two or more bales.

12. The tailer of claim 1, wherein:
a guide skirt, being a flexible polymer sheet that extends along a length of an edge of the bed.

13. The tailer of claim 12, wherein:
the skirt can flex in accordance with a movement of the stabilisers.

14. The tailer of claim 1, wherein:
a compression station further comprises a rotating crank arm to which is attached a rigid upright, the rotation of the arm acting to compress a bale in the station.

15. The tailer of claim 14, wherein:
the crank arm carries a linkage that allows two or more compression station halves along one side to be operated by interconnecting them with rigid rods that extend between station halves causing simultaneous rotation of two or more of the compression station halves.

16. The tailer of claim 14, wherein:
an upright is rotated by a shaft that is inclined with respect to vertical;
the shaft rotated in either direction to engage or disengage with a bale.

17. (canceled)

18. The tailer of claim 1, wherein:
the longitudinal conveyor is a chain conveyor.

19. (canceled)

20. (canceled)

21. A trailer for carrying over sized bales, comprising:
a wheel assembly;
a flat bed that pivots about the wheel assembly;
the flat bed comprising a longitudinal conveyor and one or more compression stations for reducing the effective width of a bale;
wherein the one or more compression stations each include a pair of stabilisers located on opposite side edges of the bed;
each compression station adapted to have a compressed orientation
wherein a stationary bale on the bed is laterally compressed to a roadable width and an open orientation wherein the bale is not compressed;
each compression station comprising a pair of opposing stabilisers, each stabiliser comprising a rigid post that is pivoted at its lower end with respect to the bed; and
a gate.

22. The trailer of claim 21, wherein:
a compression station further comprises a hydraulic rotating crank arm to which is attached a rigid upright, the rotation of arm acting to compress a bale in the station.

23. The trailer of claim 21, wherein:
a compression station further comprises two opposing posts and the posts cooperate to compress a bale.
